(19) United States
(12) Patent Application Publication
(10) Pub. No.: US 2007/0052609 A1
(43) Pub. Date: Mar. 8, 2007

(54) Dual-band or single-band dipole antenna

(75) Inventor: Chang-Jung Lee, Taoyuan County (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/209,812

(22) Filed: Aug. 24, 2005

(51) Int. Cl. H01Q 9/16

(52) U.S. Cl. 343/792; 343/791

(57) ABSTRACT

A dual-band or single-band dipole antenna comprises a first radiating unit, a second radiating unit, and a coaxial cable. The first radiating unit includes a first hollow cylinder and a first side wall. In this case, the first side wall, which is disposed on one end of the first hollow cylinder, has a protrusion portion, a first hole, and at least one groove. The first hole is disposed in the protrusion portion, and the groove is disposed on the protrusion portion. The second radiating unit includes a second hollow cylinder and a second side wall. The second side wall is disposed on one end of the second hollow cylinder. The coaxial cable includes a central conductor and an outer conductor. The central conductor is electrically connected to the first radiating unit through the first hole, and the outer conductor is electrically connected to the second radiating unit.

### BACKGROUND OF THE INVENTION

1. Field of Invention

The invention relates to an antenna and, in particular, to a dual-band or single-band dipole antenna.

2. Related Art

With the fast advancement of the wireless communication technology, various products and technologies applied in the multi-band transmission field are invented. On the other hand, new products must equip with the wireless transmission function for satisfying the demands of consumers. In a wireless transmission system, the antenna is an important component used to transmit and/or receive the electromagnetic wave. In other words, if there were no antenna, the wireless transmission system could not transmit and receive information. Therefore, the antenna is essential role in the wireless transmission system.

Referring to FIG. 1, a conventional dual-band or single-band dipole antenna 1 includes a first radiating unit 10, a second radiating unit 20, and a coaxial cable 30. In view of FIG. 2 and FIG. 3, the first radiating unit 10 includes a first hollow cylinder 11 and a first side wall 12 disposed on one end of the first hollow cylinder 11. In this case, the first side wall 12 has a first hole 121 going through the first side wall 12. Similarly, the second radiating unit 20 includes a second hollow cylinder 21 and a second side wall 22 disposed on one end of the second hollow cylinder 21. The second side wall 22 has a second hole 221 going through the second side wall 22. The coaxial cable 30 includes a central conductor 31 and an outer conductor 32. The central conductor 31 is electrically connected to the first radiating unit 10 through the first hole 121, the outer conductor 32 is electrically connected to the second radiating unit 20, and the coaxial cable 30 passes through the second hole 221.

As mentioned above, during the manufacturing processes of the dual-band or single-band dipole antenna 1, a solder 3 is used to fix the central conductor 31 in the first hole 121 by a method of welding. However, the contact area between the central conductor 31 and the first hole 121 is insufficient, and the missing solder is usually formed when welding the solder 3. Accordingly, the mechanical strength of the connection between the central conductor 31 and the first hole 121 is influenced. Therefore, during the use of the dual-band or single-band dipole antenna 1, the poor electrical engagement and, even more, the electrical disengagement between the central conductor 31 and the first radiating unit 10 may occur. Moreover, the durability of the products will be reduced.

Consequently, it is an important subject of the invention to design a dual-band or single-band dipole antenna, which can increase the connection strength between the central conductor and the solder so as to strengthen the mechanical strength of the connection between the central conductor and the first hole during the manufacturing processes of the dual-band or single-band dipole antenna. Therefore, during the use of the dual-band or single-band dipole antenna, the poor electrical engagement and, even more, the electrical disengagement between the central conductor and the first radiating unit can be eliminated.

### SUMMARY OF THE INVENTION

In view of the foregoing, the invention is to provide a dual-band or single-band dipole antenna, which is able to increase the connection strength between the central conductor and the solder during the manufacturing processes of the dual-band or single-band dipole antenna.

To achieve the above, a dual-band or single-band dipole antenna of the invention includes a first radiating unit, a second radiating unit, and a coaxial cable. The first radiating unit includes a first hollow cylinder and a first side wall, which is disposed on one end of the first hollow cylinder. In the invention, the first side wall has a protrusion portion, a first hole, and at least one groove. The first hole is disposed in the protrusion portion, and the groove is disposed on the protrusion portion. The second radiating unit includes a second hollow cylinder and a second side wall. The second side wall is disposed on one end of the second hollow cylinder. The coaxial cable includes a central conductor and an outer conductor. The central conductor is electrically connected to the first radiating unit through the first hole, and the outer conductor is electrically connected to the second radiating unit.

As mentioned above, the dual-band or single-band dipole antenna of the invention has the protrusion portion and the groove, the first hole goes through the protrusion portion, and the groove is disposed on the protrusion portion. Thus, during the manufacturing processes of the dual-band or single-band dipole antenna, the protrusion portion can increase the contact area between the central conductor and the first hole so as to increase the connection strength between the solder and the central conductor. Accordingly, the mechanical strength of the connection between the central conductor and the first hole can be further strengthened. Therefore, when using the dual-band or single-band dipole antenna of the invention, the poor electrical engagement and, even more, the electrical disengagement between the central conductor and the first radiating unit can be eliminated. As a result, the durability of the products can be enhanced.

### BRIEF DESCRIPTION OF THE DRAWINGS

The invention will become more fully understood from the detailed description given herein below illustration only, and thus is not limitative of the present invention, and wherein:

FIG. 1 is a cross-sectional diagram showing the conventional dual-band or single-band dipole antenna;

FIG. 2 is a cross-sectional diagram showing the radiating unit of the conventional dipole antenna;

FIG. 3 is a top view of the radiating unit of the conventional dual-band or single-band dipole antenna as shown in FIG. 2;

FIG. 4 is an exploded diagram showing a part of a dual-band or single-band dipole antenna according to a preferred embodiment of the invention;

FIG. 5 is a cross-sectional diagram of the dipole antenna along a line A-A′ as shown in FIG. 4;

FIG. 6 is a cross-sectional diagram of the dual-band or single-band dipole antenna along a line B-B′ as shown in FIG. 4; and

FIG. 7 is a top view of a radiating unit of the dual-band or single-band dipole antenna according to the preferred embodiment of the invention.

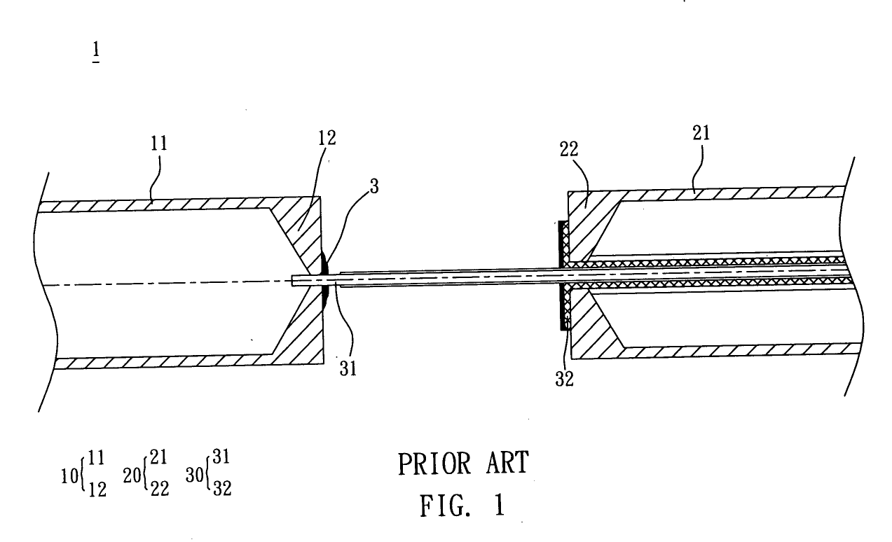

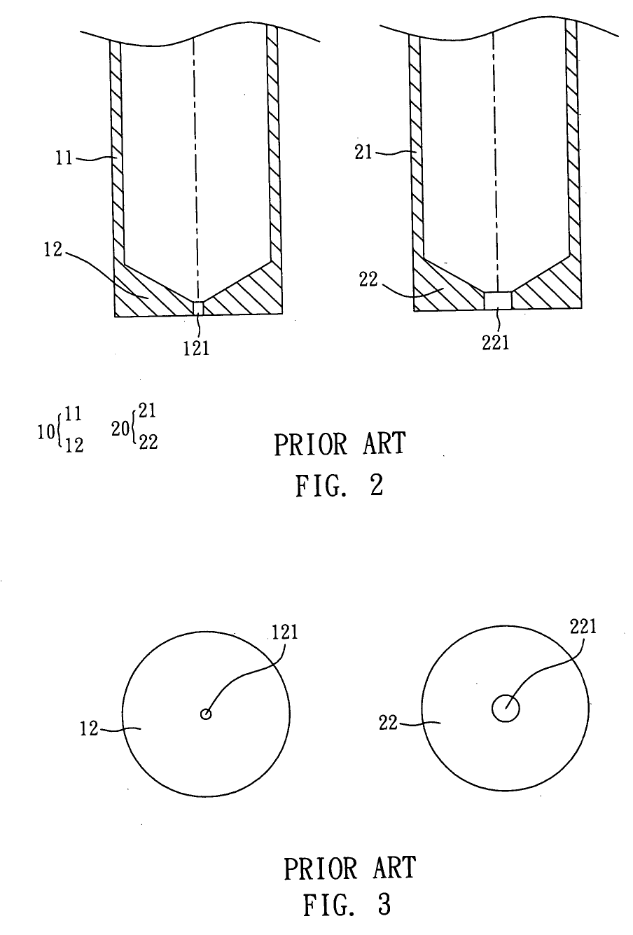

### DETAILED DESCRIPTION OF THE INVENTION

The present invention will be apparent from the following detailed description, which proceeds with reference to the accompanying drawings, wherein the same references relate to the same elements.

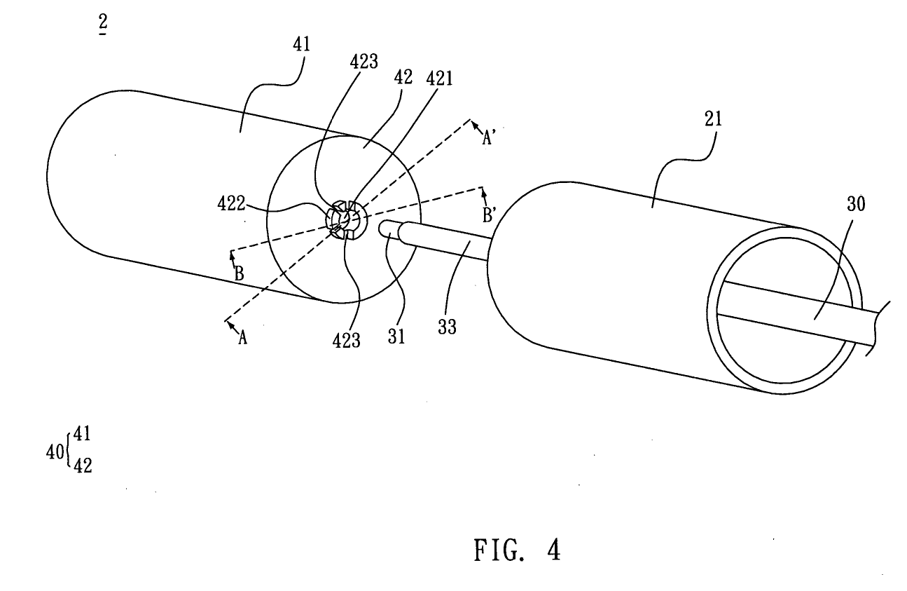

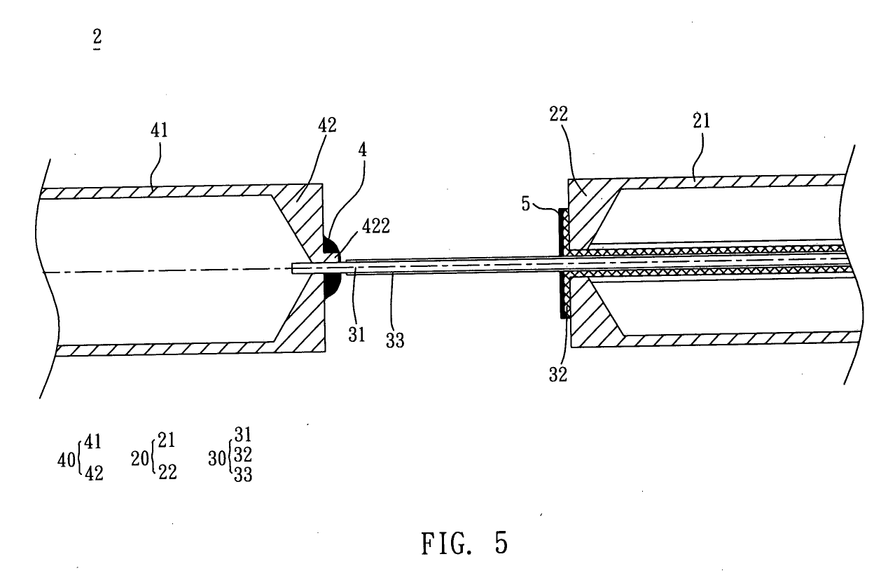

Referring to FIG. 4 and FIG. 5, a dipole antenna 2 according to a preferred embodiment of the invention includes a first radiating unit 40, a second radiating unit 20, and a coaxial cable 30.

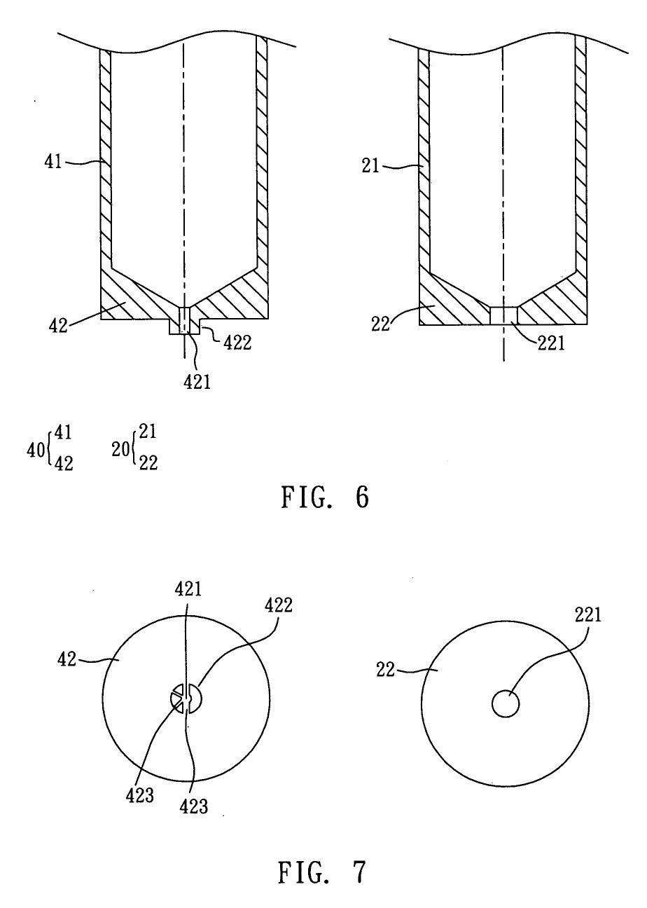

Referring to FIG. 4, FIG. 6, and FIG. 7, the first radiating unit 40 includes a first hollow cylinder 41 and a first side wall 42. The first side wall 42 is disposed on one end of the first hollow cylinder 41. As shown in FIGS. 4, 6 and 7, the first side wall 42 has a first hole 421, a protrusion portion 422, and at least one groove 423. The first hole 421 is disposed in the protrusion portion 422, and the groove 423 is disposed on the protrusion portion 422.

In the embodiment, the first hole 421 is a through hole going through the first side wall 42 according to the actual demands (as shown in FIG. 6). In addition, the configuration of the groove 423 may be designed to pass through the first hole 421, or to connect with the first hole 421 (as shown in FIG. 4). Furthermore, regarding to the practical manufacture processes, the protrusion portion 422 and the first side wall 42 are integrally formed.

The second radiating unit 20 includes a second hollow cylinder 21 and a second side wall 22. In the embodiment, the second side wall 22 is disposed on one end of the second hollow cylinder 21. The second side wall 22 has a second hole 221, which goes through the second side wall 22.

In the embodiment, the first radiating unit 40 and the second radiating unit 20 are made of metal such as copper.

Referring to FIG. 5 and FIG. 6, the coaxial cable 30 includes a central conductor 31 and an outer conductor 32. In the embodiment, the central conductor 31 is electrically connected to the first radiating unit 40 through the first hole 421, and the outer conductor 32 is electrically connected to the second radiating unit 20. In addition, the coaxial cable 30 passes through the second hole 221.

In the embodiment, the protrusion portion 422 is a feeding point, and the second side wall 22 is a grounding point. The central conductor 31 and the outer conductor 32 are electrically connected to the feeding point and the grounding point, respectively.

Referring to FIG. 5, the solder 4 is used to fix the central conductor 31 in the first hole 421 by a method of welding. As shown in FIG. 5, the solder 4 is filled in the groove 423. The groove 423 may have different configurations as described above (as shown in FIG. 4). The groove 423 is provided to prevent the missing solder. Besides, also it can increase the contact area between the central conductor 31 and the first hole 421 so as to enhance the connection strength between the solder 4 and the central conductor 31. Thus, the mechanical strength of the connection between the central conductor 31 and the first hole 421 can be strengthened. In addition, one end of the outer conductor 32 is laid on the second side wall 22, and a solder 5 is used to fix the outer conductor 32 on the second side wall 22 by a method of welding.

In this embodiment, the coaxial cable 30, which can be the commonly used signal transmission line in the industry, further includes an insulator 33, which is made of Teflon. The insulator 33 is provided to cover the central conductor 31 and is disposed between the central conductor 31 and the outer conductor 32.

In summary, the dual-band or single-band dipole antenna of the invention has the protrusion portion and the groove, the first hole goes through the protrusion portion, and the groove is disposed on the protrusion portion. Thus, during the manufacturing processes of the dual-band or single-band dipole antenna, the protrusion portion can increase the contact area between the central conductor and the first hole so as to increase the connection strength between the solder and the central conductor. Accordingly, the mechanical strength of the connection between the central conductor and the first hole can be strengthened. Therefore, when using the dual-band or single-band dipole antenna of the invention, the poor electrical engagement and, even more, the electrical disengagement between the central conductor and the first radiating unit can be eliminated. As a result, the durability of the products can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dual-band or single-band dipole antenna, comprising
a first radiating unit, which includes a first hollow cylinder and a first side wall, wherein the first side wall is disposed on one end of the first hollow cylinder and has a protrusion portion, a first hole, and at least one groove, the first hole is disposed in the protrusion portion, and the groove is disposed on the protrusion portion;
a second radiating unit, which includes a second hollow cylinder and a second side wall, wherein the second side wall is disposed on one end of the second hollow cylinder, and
a coaxial cable, which includes a central conductor and an outer conductor, wherein the central conductor is electrically connected to the first radiating unit through the first hole, and the outer conductor is electrically connected to the second radiating unit.

2. The dual-band or single-band dipole antenna of claim 1, wherein the protrusion portion is a feeding point, and the central conductor is electrically connected to the feeding point.

3. The dual-band or single-band dipole antenna of claim 1, wherein the protrusion portion and the first side wall are integrally formed.

4. The dual-band or single-band dipole antenna of claim 1, wherein the first radiating unit and the second radiating unit are made of metal.

5. The dual-band or single-band dipole antenna of claim 1, wherein the first radiating unit and the second radiating unit are made of copper.

6. The dual-band or single-band dipole antenna of claim 1, wherein the first hole is a through hole.

7. The dual-band or single-band dipole antenna of claim 6, wherein the first hole goes through the first side wall.

8. The dual-band or single-band dipole antenna of claim 1, wherein the groove passes through the first hole.

9. The dual-band or single-band dipole antenna of claim 1, wherein the groove is connected to the first hole.

10. The dual-band or single-band dipole antenna of claim 1, wherein a solder is used to fix the central conductor in the first hole by a method of welding.

11. The dual-band or single-band dipole antenna of claim 1, wherein the solder is filled in the groove.

12. The dual-band or single-band dipole antenna of claim 1, wherein the coaxial cable further comprises an insulator, and the insulator covers with the central conductor and is disposed between the central conductor and the outer conductor.

13. The dual-band or single-band dipole antenna of claim 12, wherein the insulator is made of Teflon.

14. The dual-band or single-band dipole antenna of claim 12, wherein the second side wall is a grounding point, and the outer conductor is electrically connected to the grounding point.

15. The dual-band or single-band dipole antenna of claim 1, wherein a solder is used to fix the outer conductor on the second side wall by a method of welding.

16. The dual-band or single-band dipole antenna of claim 1, wherein the second side wall comprises a second hole, the second hole goes through the second side wall, and the coaxial cable passes through the second hole.

17. The dual-band or single-band dipole antenna of claim 1, wherein one end of the outer conductor is laid on the second side wall.
